(19) United States
(12) Patent Application Publication
(10) Pub. No.: US 2009/0035623 A1
(43) Pub. Date: Feb. 5, 2009

(54) Functional product, treatment device of functional substance, applied device of functional product and mounting method of functional product

(76) Inventor: Nobuyoshi Tsuji, Tokyo (JP)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/658,376

(22) PCT Filed: Jul. 26, 2005
(86) PCT No.: PCT/JP2005/014001

§ 371 Date: Aug. 26, 2008

(30) Foreign Application Priority Data
Jul. 26, 2004 (JP) 2004-216765
Oct. 29, 2004 (JP) 2004-316995
Dec. 16, 2004 (JP) 2004-365062
Jan. 14, 2005 (JP) 2005-008437
Mar. 28, 2005 (JP) 2005-092290

(51) Int. Cl. H01M 8/18; B05D 3/06

(52) U.S. Cl. 429/19; 427/554

(57) ABSTRACT

The present invention relates to a production and a usage of a functional substance of a fine powder of nanometer size, and to an improved treatment device of the functional substance and an improved applied device of a functional product, further, to a weight reduction of a device using the functional substance and a production cost reduction.

The functional product uses a functional product means in which a fine functional powder of nanometer size or a fine functional powder of nanometer size packed together using a coating material is made into a solid or granular membrane. A treatment device of a functional substance comprises: single or plural of treatment container means which is a pressure-resistant container provided with a flange, a jacket and a temperature control section; a hydrogen filling means having a deaerating device and a hydrogen storage and release device which are mounted on said pressure-resistance container; a heating and cooling device having a heating device and a cooling device which are mounted on each of said pressure-resistant container and said hydrogen storage and release device; and an electric control means for automatically controlling said treatment container, said hydrogen filling means and said heating and cooling means. A storage device for a functional product comprises a energy conversion and storage means for sealing and storing a functional product, which has been subjected to a reduction and a hydrogenation of a functional substance using natural or regenerable energy, in a waterproof container or bag. A molded product, a painting material, a coating material and a grouting material using said functional product comprises a catalytic means in which a material, a binder and a functional catalytic product are mixed and dispersed. A hydrogen solvent using said functional product comprises a hydrogen solution means in which a functional product of a hydrogenated functional substance is mixed with a granular, solid or viscous medicine, food or adhesive membrane material, or is filled in a container. A hydrogen utilization device using said functional product comprises: a hydrogen discharge means comprising a hydrogen generating container on which a functional product consisting of a functional hydrogenated substance is mounted; a hydrogen storage and release means comprising a hydrogen storage container using a hydrogen storage substance on which a heating device is attached; a hydrogen generating means for reacting said functional product of said hydrogen discharge means with liquid water to form a metal hydride and to generate a hydrogen gas from a hydrolysis; a row material water supply means for supplying the hydrogen gas generated by said hydrogen generating means to a hydrogen utilization body and applying water being compounded with oxygen to said hydrogen generating means; and an electric control means containing a detection system; wherein these means are constructed in a unit. A gas sensor using said functional product comprises: a composite element means comprising a gas reactant on which a measuring junction of a thermoelectric couple and a functional product are mounted; a detachable means for storing said composite element means in a detachable container; and an electric control means comprising an electric control unit consisting of a power source for controlling said composite element means, a Thomson effect control system and a Seebeck effect control system and the like. A secondary battery using said functional product comprises: an electrode means formed by using a functional product of an active substance and a low-temperature plastic coating material; and an unifying means bonding power generating elements comprising a negative electrode, a positive electrode and a separation membrane of said electrode means and covering the elements with an insulation membrane. A fuel cell or reversible fuel cell in which said functional product is used in a MEA (Membrane Electrode Assembly) plate comprises: a MEA (Membrane Electrode Assembly) plate means in which a MEA (Membrane Electrode Assembly) is formed on one side of a plate formed with a corrugated portion; a stacking means stacking a single body of said MEA (Membrane Electrode Assembly) plate, a MEA (Membrane Electrode Assembly) cassette in which two of said MEA (Membrane Electrode Assembly) plates are stacked, or the MEA (Membrane Electrode assembly) cassettes; and a sealing means covering said single body of MEA (Membrane Electrode Assembly) plate or said MEA (Membrane Electrode Assembly) cassette with a coating material, or, bonding the periphery of said stacked MEA (Membrane Electrode Assembly) cassettes, sealing and separating an inside of a positive electrode or a negative electrode and providing nozzles for a fluid of two passages. Accordingly, the present invention provides the following advantages. A fine powder of a metal hydride and a metal powder made by a reduction of a metal compound can be produced at low cost. Even when a fine powder of an activated functional substance is exposed in air for a long period, it is safe and firing and poisoning do not occur. This solves a conventional problem. And, the product can be easily mounted various devices with low cost. In addition, by producing magnesium hydride using natural or renewable energy, it makes possible to convert the energy into a high-density safe substance and to store and transport. Furthermore, a large quantity of hydrogen can be supplied to a hydrogen utilization body. And, a long-lived gas sensor, secondary cell and the like can be obtained.

### TECHNICAL FIELD

The present invention relates to a production and a usage of a functional substance of a fine powder of nanometer size, and to an improved treatment device of the functional substance and an improved applied device of a functional product, further, to a weight reduction of a device using the functional substance and a production cost reduction and to diversify the device.

### BACKGROUND ART

A functional substance is used after the substance is produced in such a way that a fine powder is subjected to a mechanical grinding treatment or the like to have a larger surface area per unit mass in order to enhance its functionality. Such functional substances are disclosed in Japanese published unexamined application Nos. 2004-290811, 2004-268022 and 2004-174414.

In a case in which a functional substance is a hydrogen storage alloy, since the substance is covered with an oxide film in a produced state, a progression of hydrogenation is impaired resulting in decreasing of its hydrogen storage function. Therefore, in a device using a hydrogen storage alloy, the alloy is subjected to an activating treatment before use for smooth storing and releasing of hydrogen. Such substances and treatment methods are disclosed in Japanese published unexamined application Nos. Hei 9-31585, Hei 11-311400, 2000-17408, 2002-160901 and 2003-286001.

Generally, activating of a hydrogen storage alloy is carried out by using a hydrogen-pressurizing device in which a hydrogen pressure of a high-pressure cylinder is reduced from 140 kg/cm² to about 30 kg/cm². And, after the activating, hydrogen is discharged from the hydrogen storage alloy to the atmosphere for preventing firing, and then the hydrogen storage alloy is sealed with an inert gas and transferred. In which case, hydrogen is discharged in the atmosphere after used for the activation. In order to return a normal pressure of the hydrogen to the initial high pressure, a high-cost electric energy is necessary. So, there is a problem in which a disposal of the hydrogen is forced and the hydrogen is wasted.

And, in a hydrogen storage device such as a hydrogen storage vessel and a hydrogen container which are used by mounting a large quantity of hydrogen storage alloy, when the hydrogen storage alloy powder is activated to store hydrogen and then mounted to the device in a hydrogen stored state, the metallic powder may be reacted with oxygen in air to cause a firing during the operation.

In addition, an activated hydrogen storage alloy is covered with an oxide film again over time (poisoning) and thus a progression of hydrogenation is impaired resulting in decreasing of a hydrogen storage function. Accordingly, a pre-activated hydrogen storage alloy is mounted to the device from the beginning and then activated using a pressure-proof structure of the device. So, while an internal pressure of the hydrogen container is kept under 10 kg/cm² during a long duration of usage, the internal pressure becomes 30 kg/cm² or more when an activating operation is carried out once time before the usage in a case where the hydrogen storage alloy is installed in the device by an adhesive. In a device to which a powder having a moderate hydrogen dissociation pressure property such as LaNi based hydrogen storage alloy is installed, the device requires to have a firm container capable of withstanding under a pressure of 10 kg/cm² or more at the activating. So, a weight saving and a cost reduction of the device have been difficult.

Besides, when generating hydrogen by a hydrolysis of a functional substance, in order to enhance a hydrogen gas generating function, a metallic material is heated at high temperatures and reacted with water, or a hydride containing a dry solid acid or alkali material is reacted with water vapor to generate hydrogen for use in a fuel cell. Such materials and treating methods are disclosed in Japanese published unexamined application Nos. 2004-149394 and 2002-069558 and International application WO2003/020635.

The hydrogen generating method using a metallic material has a problem in enlarging a size of the device and also heat problem. On the other hand, the hydrogen generating method in which a hydride containing an acid or alkali material is reacted with water vapor has problem in which the device such as a proton-exchange membrane fuel cell is degraded due to the acid or alkali, hydrogen is generated at lower humidity even under suspension of the device, and the device might be burst under high pressure hydrogen since such device is not provided with a stocking means of excess hydrogen gas. So, such methods have a high dangerousness for use in a consumer proton-exchange membrane fuel cell and a hydrogen source for a hydrogen-fueled engine and are not suited for storage of hydrogen energy.

And, a nickel-hydrogen battery and a lithium-ion battery use an adhesive and the like as a binder to mount a functional substance of a fine powder used for an electrode. Such matters are disclosed in Japanese published unexamined application Nos. 2002-110244 and 2005-44672.

In electrodes of a nickel-hydrogen battery or a lithium-ion battery, a functional substance, which is an active material mounted to the negative and positive electrodes, is expanded and shrunk in volume when the substance absorbs and discharges hydrogen or Li at charging and discharging. The repeat expanding and shrinking in volume causes the functional substance to be made into a fine powder resulting in increasing of electric resistance, or removing of the functional substance from the electrode. This makes the life of the device shorten. Especially, for a negative electrode of a Li based battery, employment of a functional substance capable of obtaining a high energy density such as Sn and Si is prevented. In which case, a polymer adhesive excellent in acid resistance, alkali resistance and high temperature resistance is used for mounting the substance to the device. However, the polymer adhesive is poor in thermal plasticity at low temperatures and thus cannot withstand the repeat expanding and shrinking in volume, whereby the connective tissue may be broken. In order to solve such problems, a plating method or a vacuum evaporation method have been tried to form an active material layer of the electrode; however, such methods are complex and expensive.

Accordingly, an object of the present invention is to provide a safe functional substance which does not cause firing, poisoning and scattering even when the functional substance of a fine powder of nanometer size is formed into a membrane and exposed to air for a long period and can be mounted various types of devices with low cost. And, another object of the present invention is to provide a treatment device of a functional substance, which is able to produce a hydride powder containing metallic crystal of metal hydride and a metallic powder obtained by a reduction of a metallic compound by using natural or renewable energy.

Still another object of the present invention is to provide a container capable of storing and transporting hydrogen safely, a hydrogen generation container capable of generating a large quantity of hydrogen gas and supplying the hydrogen gas to a hydrogen utilization device safely or supplying reduction potential to an aqueous solution, a hydrogen generation agent and the like. The object is achieved by using a functional substance of metal hydride by making the substance into a fine powder of nanometer size, especially, by using a magnesium hydride and the like which can be obtained without depletion of resource and does not cause harm to environmental and a proton-exchange membrane fuel cell.

Further, still another object of the present invention is to provide an improvement in catalytic property, a long life gas sensor or secondary cell and a reversible fuel cell having no separator by using a functional substance of a fine powder of nanometer size.

### DISCLOSURE OF THE INVENTION

In the present invention, a functional product uses a functional product means in which a fine functional powder of nanometer size or a fine functional powder of nanometer size packed together using a coating material is made into a solid or granular membrane. A treatment device of a functional substance comprises: single or plural of treatment container means which is a pressure-resistant container provided with a flange, a jacket and a temperature control section; a hydrogen filling means having a deaerating device and a hydrogen storage and release device which are mounted on said pressure-resistance container; a heating and cooling device having a heating device and a cooling device which are mounted on each of said pressure-resistant container and said hydrogen storage and release device; and an electric control means for automatically controlling said treatment container, said hydrogen filling means and said heating and cooling means. A storage device for a functional product comprises a energy conversion and storage means for sealing and storing a functional product, which has been subjected to a reduction and a hydrogenation of a functional substance using natural or regenerable energy, in a waterproof container or bag. A molded product, a painting material, a coating material and a grouting material using said functional product comprises a catalytic means in which a material, a binder and a functional catalytic product are mixed and dispersed. A hydrogen solvent using said functional product comprises a hydrogen solution means in which a functional product of a hydrogenated functional substance is mixed with a granular, solid or viscous medicine, food or adhesive membrane material, or is filled in a container. A hydrogen utilization device using said functional product comprises: a hydrogen discharge means comprising a hydrogen generating container on which a functional product consisting of a functional hydrogenated substance is mounted; a hydrogen storage and release means comprising a hydrogen storage container using a hydrogen storage substance on which a heating device is attached; a hydrogen generating means for reacting said functional product of said hydrogen discharge means with liquid water to form a metal hydride and to generate a hydrogen gas from a hydrolysis; a row material water supply means for supplying the hydrogen gas generated by said hydrogen generating means to a hydrogen utilization body and applying water being compounded with oxygen to said hydrogen generating means; and an electric control means containing a detection system; wherein these means are constructed in a unit. A gas sensor using said functional product comprises: a composite element means comprising a gas reactant on which a measuring junction of a thermoelectric couple and a functional product are mounted; a detachable means for storing said composite element means in a detachable container; and an electric control means comprising an electric control unit consisting of a power source for controlling said composite element means, a Thomson effect control system and a Seebeck effect control system and the like. A secondary battery using said functional product comprises: an electrode means formed by using a functional product of an active substance and a low-temperature plastic coating material; and an unifying means bonding power generating elements comprising a negative electrode, a positive electrode and a separation membrane of said electrode means and covering the elements with an insulation membrane. A fuel cell or reversible fuel cell in which said functional product is used in a MEA (Membrane Electrode Assembly) plate comprises: a MEA (Membrane Electrode Assembly) plate means in which a MEA (Membrane Electrode Assembly) is formed on one side of a plate formed with a corrugated portion; a stacking means stacking a single body of said MEA (Membrane Electrode Assembly) plate, a MEA (Membrane Electrode Assembly) cassette in which two of said MEA (Membrane Electrode Assembly) plates are stacked, or the MEA (Membrane Electrode assembly) cassettes; and a sealing means covering said single body of MEA (Membrane Electrode Assembly) plate or said MEA (Membrane Electrode Assembly) cassette with a coating material, or, bonding the periphery of said stacked MEA (Membrane Electrode Assembly) cassettes, sealing and separating an inside of a positive electrode or a negative electrode and providing nozzles for a fluid of two passages.

The functional substance of the functional product means is made into a fine powder having a particle diameter within the range of under a minimum diameter of a fine powder which is powdered naturally in accordance with a use of the substance to 1 nm. And, the fine powder is subjected to a powdering process before use so as to be made into a finer powder of nanometer size. Such fine powder of nanometer size eliminates undesirable effect caused by a fine powdering at the time in use after the fine powder is mounted to a device. The fine powder of nanometer size allows enlarging a surface area per unit mass, causing a significant progression of an interface reaction per unit mass of the functional substance.

A suitable particle diameter is in the range of 1 nm to 3 μm. Using a fine powder having such particle diameter requires devisal for resolving various problems accompanying usage of a fine powder. For example, it is necessary that the fine powder is easily mounted, scattering and poisoning are prevented, a suitable thermal conductivity and a suitable electrical conductivity are provided, a specific substance is passed through a coating material and the like. Such problems can be solved by coating a surface of a fine powder of the produced functional substance with a thin film using a thermal plastic polymer resin. For example, in a case in which the functional substance is a hydrogen storage alloy, it becomes possible to prevent the hydrogen storage substance from being exposed to oxygen and further carbon dioxide, nitrogen and moisture in air directly and thus preventing from poisoning and an interface reaction. Alternatively, a functional substance of a fine powder is packed into a solid or coarse particles, causing improvement in a thermal conductivity and an electrical conductivity. And, when a water-soluble low-temperature plastic polymer resin in which the molecules are fluidized under 70° C., such as an aliphatic polyester based resin, is used as a coating material, the resin responds to expanding and shrinking of the functional material whereby the film can be kept in a tightly bonded state without causing cracks.

As a coating process, a conventional coating method such as a plating method and a vacuum evaporation method are expensive in a production cost. On the contrary, using of a water-soluble or organic solvent-soluble polymer resin makes it possible to make a thin film easily using water and a solvent. In a device operated at relatively low temperatures, for example, an emulsion type containing a water-soluble organic polymer resin in which lactic acid is polymerized by a chemical synthesis, such as an aliphatic polyester based resin and an polyolefin based resin, dispersed in water may be used. In addition, also general organic polymer resins may be used.

In a device operated at relatively higher temperatures, a polymer resin, called as a silicon rubber (a silicone resin), which is a polymer having a Si—O bonding as a main chain, may be used. The rubber material of the silicone is suited as a material for solidifying and adhesively bonding a granular functional product variable in volume.

When a functional substance of a fine powder of nanometer size or, a solid or granular functional product of a functional substance of a fine powder of nanometer size packed by a film material and made into a film, is mixed with a material of a molded product, a painting material, a coating material, a grouting material and the like in order to act as a catalyst, a catalytic functional substance is dispersed so as to enhance a catalytic effect. The grouting material is used for a molded product by a fiber material such as paper and leather, a furniture made of wood, a container and building material produced by solidifying concrete, waste wood chips and the like in order to add strength and improve durability, in addition to provide a catalytic function such as decomposition, antisepsis and deodorizing. The grouting material is filled in an inside or applied at a last process of a member producing process. By using such grouting material, a product having a high function can be produced at low cost.

In addition, when a functional product is used by mixing with a granular, solid or viscous medicine, food or adhesive membrane material or filling in a container, a high performance can be given. For example, when a small amount of a functional substance of a nanometer size such as a hydrogenated hydrogen storage alloy of a metal and a metal hydride and a magnesium hydride is added to a solid medicine or food, such as powder or tablet, the metal is dissolved in water solution as a mineral. In a case of a magnesium hydride and the like, depending on a drinkable water solution in use, hydrogen is generated by a hydrolysis and the metal hydride, and the hydrogen is dissolved in the water solution. By the dissolution of the hydrogen in the water solution, the water solution can have a mineral contained therein, and a reduction of potential and an alkaline pH value. Accordingly, a cell activation such as a sterilization and a removing of active oxygen is caused, which is good for health. When a functional product of a hydrogenated hydrogen storage alloy is added in a tablet, hydrogen is released in the same way accordance with a temperature of a solution and dissolved in the solution.

When a functional product of a fine powder of a metal hydride, such as a magnesium hydride fine powder of nanometer size, is filled into a container and put in bathwater, wash water and fish farm water, hydrogen generated by a hydrolysis is dissolved in a water solution so that such water is used as a functional water having a reduced potential and an alkaline pH value in the same manner.

For the purpose of generating hydrogen accompanied with a hydrolysis, in a case of a hydrogen utilization device in which a functional product of a metal hydride of nanometer size is filled in a hydrogen generating container and used, the hydrogen generating container is charged with water by a controlled pump while being heated using exhaust heat from the hydrogen utilization body, resulting in generating a large quantity of a hydrogen gas. For example, when a functional product produced such that a functional product of a magnesium hydride as a safe metal hydride is made into a film by using an emulsion containing a low-temperature plastic aliphatic polyester based polymer resin dispersed in water is exposed to water, a suitable quantity of water is passed through the polymer resin and thus a large quantity of hydrogen is generated by a hydrolysis and the metal hydride. So, it makes possible to supply hydrogen to a hydrogen utilization body, such as a proton-exchange membrane fuel cell and peripheral equipments, without causing damage of an acid and an alkali. In the hydrogen utilization body supplied with hydrogen, oxygen is compounded with hydrogen to generate water. The water can be directly circulated in the hydrogen-generating device because the water does not contain an acid and an alkali. So, a raw material water used in a hydrolysis can be obtained without supplying water from outside.

In a hydrolysis of magnesium, it is well known that a magnesium hydride generated by a reaction of a hydrolysis forms a film on a surface of the metal and thus the reaction of the hydrolysis is impaired. So, a hydrogen fuel generating method using magnesium and water has not put in practical use yet. Therefore, the inventor's propose provides a new technique in which a magnesium hydride is made into a fine powder having a particle diameter of nanometer size and made into a film using a water-permeable coating material. By using the technique, the reaction is finished before the magnesium hydride forms a film having a thickness which impairs the reaction of the hydrolysis.

Use of this technique can solve problems in a conventional hydrogen generating technique using a hydrogenated substance containing acid and alkali materials. For example, according to the technique disclosed in International Patent Application No. WO2003/020635, when a publicly known hydrogenated substance containing an acid material and an alkali material is applied to water, the reaction is explosively progressed and controlling of the reaction becomes difficult, thus the hydrolysis is carried out using water vapor in exchange for liquid water. By applying a functional product technique according to the present invention, even if liquid water is used, since a suitable amount of water is passed through a coating film of a polymer resin, a reaction of a hydrolysis is gradually proceeded and controllable. So, a safe hydrogen-generating device can be provided for civic customers.

For the purpose of detecting gas, in a case of a gas sensor using a thermoelectric couple, a functional substance is selected so as to be suitable for a gas to be detected and used as a gas reactant. For example, when a functional product of a hydrogen storage alloy made into a film is mounted around a conductive junction of the thermoelectric couple, poisoning is prevented even if exposed to air for a long period. So, in a case in which hydrogen is mixed with ambient air, the hydrogen is selectively absorbed into the functional product to cause a hydrogenation and thus to generate heat, and the heat is detected by the thermoelectric couple. So, the gas sensor is functioned as a hydrogen-detecting sensor.

For the purpose of storing hydrogen, in a case of a small-size low-pressure hydrogen storage container used in a fuel cell and the like, a functional substance of nanometer size, in addition to a complex material, such as a magnesium hydride and a lithium hydride of nanometer size, made into a film is mixed with a binder. And, the mixture is solidified and filled into a device or adhered to the device. This does not cause an expansion braking by tilt due to vibration and prevents from poisoning even if left to stand in air for a long period. And, an activation and a charging of hydrogen can be carried out intensively.

In addition, for the purpose of storing hydrogen, in a case of a large-size hydrogen storage vessel such as a hydrogen container and a hydrogen storage equipment, in the same manner, a various types of granular functional substance made into a film is mixed with a binder and solidified. Then, the solidified mixture is mounted by filling in an outside or an inside of a pipe of the device. In addition, a granular functional substance made into a film is activated, mixed with a binder and made into a paste using an organic solvent. And, the paste is solidified and mounted to the device by filling in the outside or the inside of the pipe of the device. Or, the paste is solidified and adhered to a groove of a corrugated plate. By such methods, since the substance is mounted after activation and thus an activation after mounting is not necessary, the large-size container does not require a firm structure against high pressure.

For the purpose of purifying hydrogen, in a case of a hydrogen purifying device of a reformed gas and a low-purity hydrogen gas, a granular functional substance made into a film or a mixture of a granular functional substance made into a film and a binder is solidified and activated. Then, the substance or the mixture is mounted to the device by filling in an inside of the device or the inside or an outside of a pipe of the device. And, the substance or the mixture is easily solidified and adhered to the inside or the outside of the pipe of the device or a groove of a corrugated plate of the device. In which cases, since an activation is not necessary after activation, the large-size container does not require a firm structure against high pressure.

In addition, for the purpose of purifying hydrogen, in a case of hydrogen purifying membrane, a fine powder of a functional substance or a granular functional substance made into a film is mixed with a hydrogen purifying membrane material and formed into a pipe shape or a sheet shape. Then, the formed product is activated and then mounted to the device. Alternatively, the product is applied to selectively absorbing methane gas and the like and to a device of purifying and storing.

For the purpose of a heat pump, in a case of a device for collecting heat generated by a hydrogenation and a hydrogen release, a granular hydrogen storage alloy made into a film or a mixture of a granular hydrogen storage alloy made into a film and a binder is solidified and activated. Then, the substance or the mixture is mounted to the device by filling in the inside of the device or an inside or an outside of a pipe of the device. And, the substance or the mixture is easily solidified and adhered to the inside of the device, the inside and the outside of the pipe of the device and a groove of a corrugated plate of the device. In which cases, since an activation is not necessary after activation, the large-size container does not require a firm structure against high pressure.

For the purpose of pressurizing hydrogen, in a case of a device for hydrogen pressurizing and hydrogen storing and releasing for activation, a granular hydrogen storage alloy made into a film or, a mixture of a granular hydrogen storage alloy made into a film and a binder, is solidified and activated. Then, the substance or the mixture is mounted to the device by filling in the inside of the device or an inside or an outside of a pipe of the device. And, the substance or the mixture is easily solidified and adhered to the inside of the device, the inside and the outside of the pipe of the device and a groove of a corrugated plate of the device.

A hydrogen storage and release device mounting these hydrogen store alloys is combined with a pressure-resistant vessel and is used as a treatment device of a functional substance. In a hydrogen release process of the hydrogen storage and release device, by heating using low-temperature exhaust heat, a hydrogen pressure is increased up to about 30 kg/cm² so as to activate a functional product in the pressure-resistant vessel. In a hydrogen storage process, by cooling using a cooling medium, hydrogen which has been stored in the functional product at the activation of the pressure-resistant vessel is returned to the hydrogen storage and release device again. So, the returned hydrogen can be recycled in preparation for a hydrogen release process of next activation. And, because of a hydrogen purifying performance of the functional product, the purity of the hydrogen does not deteriorate even if the hydrogen is used repeatedly.

By using the treatment device of a functional substance, a functional substance of a hydrogenated fine powder of nanometer size can be obtained with a high efficiency as explained below. Coarse particles of a functional substance of a metal or an alloy are put in a pressure-resistance vessel and a high-pressure hydrogen is introduced to the vessel. The vessel is equipped with a temperature control section having a heating wire, a thermoelectric plug, a laser irradiation plug and the like. By using such elements, one end of the functional substance is heated at high temperatures and fired. This causes a combustion synthesis using self-heating by a hydrogenation reaction. So, a hydrogenated fine powder containing a metal crystal of nanometer size can be obtained with row cost.

In a case of a treatment device of a functional substance equipped with a laser irradiation plug, a material such as metal compound and the like is heated at high temperatures, separated by gasifying and then cooled, causing a reduction of the metal. Specifically, the reduction of a metal is carried out in such a way that, for example, coarse particles of magnesium oxide and the like are put in a pressure-resistant container, the magnesium oxide is irradiated with a laser, which is generated using a renewable energy including natural energy and nuclear fusion energy and emitted from the laser irradiation plug of the temperature control section, and heated at high temperatures to be gasified. And, oxygen is discharged and the gas of magnesium is cooled to produce a fine powder metal.

When a functional product produced by a reduction and a hydrogenation of a functional substance using a natural or renewable energy is tightly sealed in a container or bag, the natural or renewable energy can be stored and transported as a high-density safe substance.

Mounting a functional substance of nanometer size mounted to an electrode foil of a nickel-hydrogen battery or a lithium metal battery by using a low-temperature plastic polymer resin as an active material will prevent the active material from being made into a fine powder due to expansion and shrinking by storing and releasing of hydrogen and lithium and removing from the electrode foil. And, when power generating elements containing a negative electrode, a positive electrode and a separation membrane are combined together by covering with a insulating film, a functionality of the power generating elements can be increased and a secondary cell can have a long life.

And, when a functional product is mixed with a binder using a solvent to form a paste, the paste can be applied to a curved surface easily. So, a reversible fuel cell using a corrugated electrode plate can be provided. A functional substance is selected so as to be suited for each membrane layer of power generating elements of a MEA (Membrane Electrode Assembly). Single body of a MEA (Membrane Electrode Assembly) plate, a MEA (Membrane Electrode Assembly) cassette in which two of a MEA (Membrane Electrode Assembly) plate is stacked, or a stacked product in which the MEA (Membrane Electrode Assembly) cassette is stacked, is used as a simple reversible fuel cell having no separator. Alternatively, a single body of a MEA (Membrane Electrode Assembly) or the MEA (Membrane Electrode Assembly) cassette is covered with an outer film, or the periphery of the stacked MEA (Membrane Electrode Assembly) cassette is bonded, the inside of the positive electrode or a negative electrode is sealed and separated. And, each nozzle for fluids of two passages is mounted for tight seal, providing a simple reversible fuel cell having no separator.

### BRIEF DESCRIPTION OF THE DRAWINGS

FIG. 1 is a block diagram showing an entire structure of a treatment device of a functional substance according to one embodiment of the present invention.

FIG. 2 is a sectional drawing showing a mounted functional substance according to one embodiment of the present invention.

FIG. 3 and FIG. 4 are drawings showing a plate according to one embodiment of the present invention.

FIG. 5 is a drawing showing a production process of a stacked product according to one embodiment of the present invention.

FIG. 6 is a block diagram showing an entire structure of a hydrogen utilization device according to one embodiment of the present invention.

FIG. 7 is a sectional drawing showing a gas sensor according to one embodiment of the present invention.

FIG. 8 is an expansion drawing showing a cylindrical secondary cell according to one embodiment of the present invention.

FIG. 9 is a sectional drawing showing an electric power-generating element of a secondary cell according to one embodiment of the present invention.

FIG. 10 is a sectional drawing showing a MEA (membrane-electrode assembly) plate according to one embodiment of the present invention.

### BEST EMBODIMENT TO CARRY OUT THE INVENTION

Hereinafter, embodiments of the present invention will be described with reference to the accompanying drawings.

### Embodiment 1

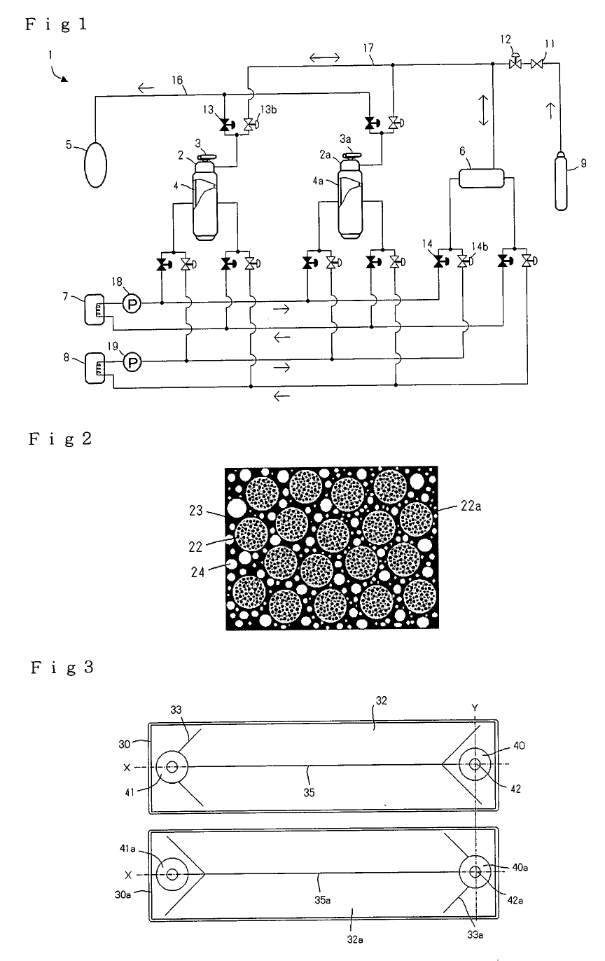

Referring to FIG. 2, a plurality of particles of a functional substance of a fine powder of nanometer size are packed with a low-temperature plastic polymer resin and formed into a film, producing coarse functional products 22 and 22a. The coarse functional products 22 and 22a are solidified with a binder 23 such as silicon rubber and the like and adhesively mounted to an inside of an apparatus and the like.

Specific examples of a material of the functional substance are halogen elements, such as iodine, and their compounds; oxygen group elements, such as sulfur and selenium, their alloys and compounds; nitrogen group elements, such as arsenic, antimony and bismuth, and their alloys and compounds; carbon group elements, such as carbon, silicon and tin, and their alloys and compounds, alkali metal elements, such as lithium, sodium and potassium, and their alloys and compounds; alkaline-earth metal elements, such as beryllium, magnesium and calcium, and their alloys and compounds; zinc, cadmium and mercury and their alloys and compounds; boron group elements, such as boron, aluminum and gallium, and their alloys and compounds; forth periodic group transition elements, such as titanium, chrome, manganese, iron and nickel; fifth periodic group transition elements, such as zirconium, ruthenium and palladium; sixth periodic group transition elements, such as lanthanum, tantalum and platinum; seventh periodic transition elements, such as thorium; and alloys and compounds of the transition elements. One or two or more kinds of the materials may be selected if necessary and used.

A fine powder treatment process such as a grinding treatment for grinding a functional substance into a fine powder having a desired particle diameter of 3 μm to 1 nm, a hydrogenating treatment and a vapor phase synthesizing treatment will be explained. When a carbonaceous material and metallic particles are subjected to a mechanical grinding treatment under hydrogen atmosphere to produce a functional substance, for example, graphite particles and metallic lithium particles are sealed with plurality of steel balls in a steel milling container equipped with a hydrogen induction valve, and after deaerating the container, hydrogen is introduced into the container at 1.0 Mpa. Thereafter, the mixture is milled at room temperature for 80 to 100 hours. This provides a functional substance of a fine powder to which a lattice defect is introduced.

When a functional substance is produced by a gas phase reaction, for example, a metallic fine powder of a magnesium gas or a magnesium and nickel gas, which in generated at temperature higher than the boiling point, is introduced into a reactor from one side of the reactor and a mixture gas of carbon and hydrogen, which are generated by decomposition of a carbon hydride, is introduced into the reactor from another side of the reactor. In the reactor, a gas phase reaction occurs to produce of a functional substance of a fine powder of a complex compound of a magnesium and nickel fine powder and a carbon material.

Further, when a functional substance is produced by gas phase reaction, for example, a carbonaceous material and an alkali metal are placed with a distance therebetween in a reactor and then the reactor is evacuated. Controlling each temperature of the carbonaceous material and the alkali metal causes a reaction to produce a functional substance of a fine powder in which metallic elements of the alkali metal are inserted between planer molecular layers of the carbonaceous material.

A producing method of a functional substance by a hydrogen storage alloy will be explained. As hydrogen storage alloys, Ca, La, Mg, Ni and Ti, and the third element of V system are known, for example. The materials are prepared and dissolved to produce a cast hydrogen storage alloy such as a La—Ni based alloy and an Mg—Ti based alloy. Then, after being to store hydrogen, the alloys are subjected to an initial grinding treatment or a mechanical grinding treatment to produce a fine powder of the hydrogen storage substance. In addition, a fine powder of a metal, an alloy and Mg, as a functional substance, is charged in a pressure-resistant vessel, high-pressure hydrogen is introduced in the vessel and then one parts of the powder of the functional substance is heated at high temperatures and fired to cause a combustion synthesis using self-heating due to a hydrogenation reaction, producing a fine powder of nanometer size containing a metallic crystal of a Mg—Ni—Fe based, Ti—Cr—V based or Mg—Ca—Ni based alloy or a metal hydride such as Al and Mg. And, as a similar way, the material is heated at high temperatures by a laser radiation to be gasified and cooled to produce a fine powder.

And, when a hydrogen absorption material and a hydrogen storage alloy are used for producing a functional substance, for example, a powder of carbonaceous material having a graphite structure or an amorphous structure, and one or more kinds of a hydrogen storage alloy powder, a carbide powder and an oxide powder are mixed and the mixture is subjected to a mechanical grinding using an inert gas to produce a functional substance of a fine powder of nanometer size. In a publicly known catalytic material, a functional substance of a fine powder is produced in the same way.

If thus produced functional substance of a fine powder has an average particle diameter of 20 nm, its specific surface is about 45 m²/g. On the other hand, in a case of a powder having an average particle diameter of 0.5 μm, its specific surface is about 1 m²/g. That is, a fine powder of nanometer size can have a far larger specific surface. Accordingly, it is expected to improve a hydrogen storage property, a property for absorbing hydrogen or methane and a catalytic action such as a deodorizing action and a decomposing action, and further to shorten a reaction time per unit mass at a hydrolysis.

The produced functional substance of a fine powder of nanometer size is subjected to a coating process. As a material of a film, a low temperature plastic aliphatic polyester (TERRAMAC (trade mark), manufactured by Unitika Ltd. and the like), polyolefin (AROWBASE (trade name), manufactured by Unitika Ltd., and further tetrafluoroethylene, an emulsion type water-soluble polymer resin dispersed in water and the like are used. The film material is diluted by adding water and kneaded with a functional substance of a fine powder. Then, the mixture is dried by heating at 110° C. to 150° C. to cause a glass transfer and to form a crystallized film having a thickness of 1 to 5 μm. Also, an aliphatic polyester based resin is ground after drying to form a fine powder. Then, the film material in a suitable amount required for forming a crystallized film having a thickness of 1 to 5 μm around a particle of a functional substance and a functional substance of a fine powder are prepared and mixed. And, the mixture is heated at 110° C. to 150° C. using electrothermal pressure rollers. By this heating, the film material is subjected to a glass transfer and is crystallized, forming a film. In addition, a water-soluble polymer resin such as tetrafluoroethylene is suitably prepared and diluted by adding water to prepare a solution of the polymer. And, the solution and a functional substance of a fine powder are kneaded and crystallized by a heated-air dryer to produce a film. Even in a case of an organic polymer resin which is a plastics raw material, the resin is diluted with an organic solvent, kneaded with a functional substance of a fine powder of nanometer size and then heated, or the organic polymer resin is made into a fine powder, mixed with a functional substance of a fine powder and then heated to form a film in the same way. Thus coated solid by the aforesaid methods may be produced as coarse particles grinded to have a desired particle diameter for any purpose.

By producing a functional product of a functional substance in the aforesaid way, even a functional product of a fine powder of nanometer size, the fine powder can be in close contact each other by an adhesive action of the polymer resin so as to prevent poisoning and scattering, and provide a functional product in a granular form having a suitable particle diameter of several tens of micron to several microns or a solid form. And, the close contact of the fine powder allows increasing of a thermal conductivity and an electrical conductivity. On the other hand, if the functional product is mounted to a device and the film cracks during a pass of operation time, in a case of a low-temperature plastic polymer resin, the crack self-repairs by using exhaust heat from the device.

A mounting method of a functional product to various devices will be explained. A granular functional product made into a film and a binder are kneaded to form a paste, and the paste is heated to be solidified into a suitable shape. Then, the shaped solid is mounted to the device by filling in the device or an inside or an outside of a pipe of the device. Or, the paste is coated on a groove of a corrugated plate or an electrode and then dried or heated to be solidified and adhered.

Besides, a paste produced by kneading a functional product of a functional substance of a fine powder of nanometer size and a binder is coated on an inside of an objective device, an inside or an outside of a pipe of the device, a groove of a corrugated plate or an electrode, and then dried or heated to be solidified and adhered. Thereafter, on a surface of the solidified paste, a water-soluble or an organic solvent-soluble low-temperature plastic polymer resin diluted with a solvent is coated to form a film.

And, a paste produced by kneading a functional product of a functional substance of a fine powder of nanometer size and a film material diluted with a solvent is coated on an inside of an objective device or an electrode, and then heated and dried to be solidified and adhered, and then pressed if necessary.

As the binder, for example, fluorocarbon resins such as polytetrafluoroethylene (PTFE), polychlorotrifluoroethylene (PCTEF), polyvinylidene fluoride (PVDF) and publicly known polymer resins such as styrene-butadiene rubber and carboxy cellulose may be used.

In the case of a polymer resin which has a Si—O bonding as a main chain and is called as a silicone rubber (silicon resin), because of its high heat-resistant temperature, a paste in which a mixture of a functional product and a rubber material is kneaded after adding a solvent is used and mounted in the same manner. For example, when a hydrogen storage method using a complex such as magnesium amide and lithium hydride is used, a fine powder of magnesium nitride, lithium nitride and the like of nanometer size is mixed and formed to adhere to the device in the same manner.

In a storage container of a functional product, a fine powder of magnesium hydroxide and the like and a powder produced by drying a aliphatic polyester based resin and the like are mixed and heated to cause a glass transition and then ground into particles having a suitable particle diameter. Then, the particles are tightly sealed in a water-resistant container or bag.

Not shown, when a functional product having a catalytic property is used for a material of a molded product, a painting material, a coating material or a grouting material, a functional substance of a fine powder of nanometer size, or a solid or coarse granular functional product produced by packing a fine powder of nanometer size and forming into a film is mixed with the material of the molded product such as a polymer resin, the painting material such as a paint, the coating material such as a fiber and a film, dispersed therein. And, in the case of the grouting material, a functional substance of a fine powder of nanometer size is efficiently mixed with a reinforcing material or a water-resistant material and then used. In usage of the grouting material, a molded product of a fiber material such as paper and leather, a part of a furniture made of wood, a molded article produced by solidifying waste wood chips is charged into a chamber and the chamber is evacuated. Then, a diluted liquid grouting material is absorbed into the product and then dried. In a case of a concrete of a building, preferably, after drying and solidifying, the concrete is coated with the liquid grouting material so as to absorb the grouting material.

And, when a functional product is used as a hydrogen solvent, a functional product or a functional product of a hydrogenated functional substance is mixed into a granular, solid or viscous medicine or food, or adhesive membrane material, or filled into a container to be produced. For example, in a case of a granular, tablet or jellylike medicine or food, a small amount of a functional product using a metal or a metal hydride such as magnesium hydroxide having a nanometer size is added in the material. In a case of a painting material, an adhesive membrane material (bandage and cotton gauze), a gum, a tablet and a dried product (tea and green tea) which are not eaten directly, a functional product is mixed with the material, the mixture is solidified with an organic polymer material of a coating material, or after solidifying, the mixture is ground and then produced. As the coating material of a functional product used as a food, publicly known organic edible polymers are preferable.

In a producing of a tablet, a powder of an objective substance such as food, nutritional supplement and medicine and a powder produced by drying a functional product and a coating material are mixed and formed using a die into a tablet, and then heated. Or, the powders are mixed and formed using a die into a tablet, and the tablet is coated with a liquid organic polymer and then heated.

In a case of a container used for producing a functional water in which hydrogen is dissolved in bathwater, wash water and fish farm water using a functional product, a fine powder of magnesium hydride and a powder produced by drying an aliphatic polyester resin are mixed in a hydrogen generating container formed with a plurality of fine pores into which water can enter, and then dried by heating at 110° C. to cause a glass transition to be solidified. Then, the solid is ground into particles having a suitable particle diameter and filled into the hydrogen-generating container.

An experiment for giving a reduction potential to a solution by using those hydrogen solvents will be explained. 1 g of magnesium hydride as a functional product and 1 little of drinkable water of 25° C. are used, and a concentration of hydrogen, an oxidation-reduction potential (ORP) and a pH value are measured. A powder of the magnesium hydride is added into the drinkable water, and after about two minutes from the start of dissolution of hydrogen, a concentration of hydrogen and an oxidation-reduction potential (ORP) are measured. As a result, the concentration of hydrogen is 0.4 ppm and the oxidation-reduction potential (ORP) is −100 mV. Thereafter, the concentration of hydrogen is decreased to 0.5 ppm and the oxidation-reduction potential (ORP) is decreased to −400 mV. After about 8 minutes from the start of the dissolution of hydrogen, the concentration of hydrogen is kept at 1.2 ppm and the oxidation-reduction potential (ORP) is kept at −600 mV.

At the same time, a pH value is measured after about 5 minutes from the start of dissolution of hydrogen. As a result, the pH value is pH7, at which time the oxidation-reduction potential (ORP) is about −600 mV. Then, the pH value is decreased to about pH7.7 and kept the value.

After leaving to stand the solution into which hydrogen is dissolved at room temperatures, a concentration of hydrogen and an oxidation-reduction potential (ORP) are measured. A time required to returning the concentration of hydrogen and the oxidation-reduction potential to each initial value is about 3 hours or longer.

Those values are close to the values of a functional water in which hydrogen is dissolved in pure water used in an industrial cleaning process. Accordingly, a solution used in bathwater, washing water and fish farm water can have a suitable oxidation-reduction potential without use of a water electrolytic device.

In addition, as a device using a functional product, a fuel cell, a water electrolytic device and a secondary cell such as a nickel hydride battery and a lithium metal battery are given. A positive electrode, a negative electrode, a separation membrane and various types of membrane layers of electrolyte are made of using a suitable functional product. Details will be described in the later mentioned embodiments.

In a device to which such functional product is mounted, in addition to a hydrogen detecting device, a heat pump, a hydrogen purifying device and a hydrogen pressurizing device, in a hydrogen storage and release device, a time for storing and releasing hydrogen is shortened because of high heat conductivity of the functional product, causing an improvement in efficiency. On the other hand, for example, in an electrode of a secondary battery, for example, such product will prevent a hydrogen storage alloy of a Ni-hydrogen battery and a functional substance such as Sn and Si of a lithium-metal battery from being made into a fine powder due to repeating storing and releasing of hydrogen and lithium and removing, and prevent decreasing of an electric conductivity.

### Embodiment 2

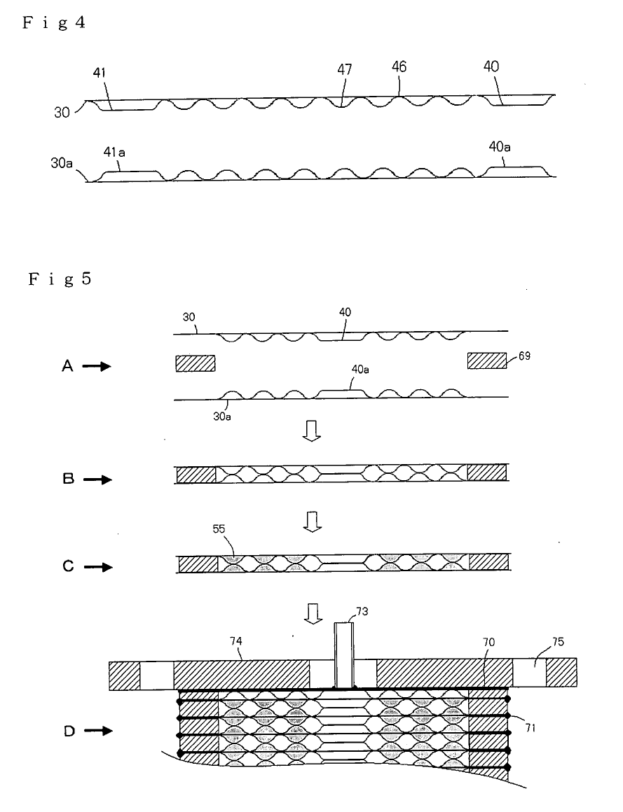

A hydrogen storage and release device 6 according to this embodiment will be explained with reference to FIGS. 3 to 5. FIG. 4 is a sectional drawing viewed from a X-Line of FIG. 3. One plate 30 is made of a rectangular metal plate formed with concave plane portions 40 and 41 at both ends thereof, a hydrogen introduction groove 35 extending in the longitudinal direction at the center thereof and a corrugated portion 32. Each of the concave plane portions 40 and 41 has a hydrogen hole 42. On the corrugated portion 32, a plurality of straight grooves 33 inclined with respect to the hydrogen introduction groove 35 at 45° are parallel formed over the corrugated portion 32.

The other plate 30a is made of a rectangular metal plate formed with convex plane portions 40a and 41a at both ends thereof, a hydrogen introduction groove 35a extending in the longitudinal direction at the center thereof and a corrugated portion 32a. Each of the convex plane portions 40a and 41a has a hydrogen hole 42a. On the corrugated portion 32a, a plurality of straight grooves 33a inclined with respect to the hydrogen induction groove 35a at 45° in the opposite direction to the direction of the grooves 33 are parallel formed over the corrugated portion 32a. The metal plates are formed by a press working using a die.

Then, as shown in arrows A and B of the figure, boards 69 are placed between the plates 30 and 30a, and brazing films are sandwiched between the boards and the plate and between the plates. And, the plates between which the boards are placed are subjected to a high temperature treatment in a vacuum furnace so that the concave plane portion 40 is brazed to the convex plane portion 40a and the troughs of the corrugated portion 33 is brazed to the peaks of the corrugated portion 33a, resulting in forming a plate cassette. The boards 69 are joined between the longer sides of the plates parallel each other and acts as a heating medium passage extending in the longitudinal direction of the plate when the plate cassettes are stacked and also to add strength against a pressure of the hydrogen room.

Then, as shown in an arrow C of the figure, the grooves of the corrugated portions of the both sides of the plate cassette is coated with a paste 55 in which a mixture of a granular functional product made into a film and a binder is kneaded, and then the paste is solidified and adhered to the grooves. In which case, as the functional product, a hydrogen storage alloy suitable for an operating temperature range is selected and used.

Next, as shown as an arrow D in the figure, a required numbers of the plate cassette on which the functional product made into a film is mounted are stacked to form a stacked cassette. On upper and under surfaces of the stacked cassette, an end plate 70 made by joining a plane plate and a corrugated plate each other is placed. Then, the peripheral surface of the stacked cassette is welded to seal the hydrogen rooms to produce a stacked product. Then, a cap having a heating medium nozzle is mounted on the both shorter sides of the stacked product. And, to one of the hydrogen holes on the upper plate 70, a hydrogen nozzle is mounted. Thereafter, a constrained plate 74 is mounted on the upper and under surface of the stacked product via a thermal insulation board and the constrained plates are joined with a bolt penetrating a through hole 75 and a nut, and then the bolt and the nut is tightened to construct a hydrogen storage and release device. Since the hydrogen storage and release device requires one of the hydrogen hole, another hydrogen hole are closed. So, the upper end plate 70 has one hydrogen hole.

The hydrogen storage and release device having the following type has the same function as the above device. The container is constructed by pipes in which the inner and outer surfaces of the pipes are filled with a mixture in which a granular functional product made into a film shape or a powder of a functional product is mixed with a binder and solidified. Such hydrogen storage and release device has the same function and structure as a hydrogen storage device, a heat pump and a hydrogen-purifying device. Note that a hydrogen-purifying device is formed with a hydrogen nozzle at both ends of the hydrogen room in order to pass a mixing gas.

### Embodiment 3

Referring to as FIG. 1 showing a block diagram of a functional substance treatment device 1, the functional substance treatment device 1 is provided with a pressure-resistant vessel 2, a deaerating device 5, a hydrogen storage and release device 6, a hydrogen or inert gas supplying device 9, a heating device 7 and a cooling device 8, and further electromagnetic valves 12, 13, 13b, 14 and 14b, a decompression adjustment valve 11, a heat transfer medium pumps 18 and 19 and a control unit containing various types of sensors. The treatment device 1 performs a reduction of metal, a hydrogenation and grinding of a functional substance, an activation of a functional product and a hydrogen charging of the hydrogen storage container.

The pressure-resistant vessel 2 has a pressure capacity of 30 kg/cm² or more, and is provided with a jacket 4 of a heating medium, a flange and a temperature adjustment section having various types of necessary equipments such as a heating wire, a heating plug and a laser irradiating plug at the periphery surface thereof. The flange through which contents such as a metal, a functional substance and the hydrogen storage container are taken in and out is openable and closable with a hydraulic or electrically operated lid 3.

The jacket 4 serves such that the contents of the pressure-resistant vessel 2 are heated up to about 80° C. at a deaerating process and cooled to about 5° C. at a hydrogen pressurizing process by electrically controlling the electromagnetic valves 14 and 14b which pass a heating medium or a cooling medium from the heating device 7 or the cooling device 8 to the pipe.

A gas socket serves such that the contents of the pressure-resistant vessel 2 are evacuated to about 3 toor by a vacuum pump of the deaerating device 5 at a deaerating process and a hydrogen pressurizing is carried out at 30 kg/cm² or more by the hydrogen storage and release device 6 at a hydrogen pressurizing process, and an unnecessary gas is discharged into air at a reduction of a metal by electrically controlling the electromagnetic valves 13 and 13b which are connected to a deaerating system consisting of the deaerating device 5 and the hydrogen storage and release device 6 connected each other by the pipe and a pipe of a hydrogen or an inert gas system 17. One or more of thus constructed pressure-resistant container 2 may be provided.

The hydrogen storage and release device 6 has the same structure as the device shown in FIG. 3 to 5. The hydrogen storage and release device 6 serves such that a hydrogen storage alloy which is mounted on the device is heated up to about 80° C. and a hydrogen pressurizing is carried out at a hydrogen ejection pressure of 30 kg/cm² or more when the contents of the pressure-resistant vessel 2 requires a hydrogen pressurizing, on the contrary, is cooled to about 5° C. to absorb hydrogen when the contents release hydrogen by electrically controlling the electromagnetic valves 14 and 14b which supply the heating medium and the cooling medium transferred from the heating device 7 and the cooling device 8, which are installed to the heat transfer medium nozzles on both ends of the stacked product, to the pipe. As the material of the functional substance which is mounted to the hydrogen storage and release device 6, a Ti—Fe based hydrogen storage alloy and the like having a high hydrogen dissociation pressure property are suitable.

The hydrogen or inert gas supply device 9 serves to supply hydrogen to the hydrogen storage and release device 6 or supply a hydrogen or inert gas to the pressure-resistant vessel 2, and is provided with a high-pressure hydrogen or inert gas steel cylinder via a pressure adjustment valve 11.

The power sources of the heat transfer medium pump, the electromagnetic valves, the pumps of the hydraulic equipment and the like are electrically controlled in accordance with values detected by the thermal sensor or the pressure sensor and the predetermined values.

Thus constructed device allows that a powder a functional substance of a metal or an alloy is charged into the pressure-resistant vessel, high-pressure hydrogen is introduced into the vessel and one end of the functional product is heated at high temperatures to fire, resulting in hydrogenating and grinding of the functional product by a combustion synthesis using self-heating due to a hydrogenation reaction. For example, a fine powder of a metal single crystal can be easily obtained. And, a high pressurizing of hydrogen is achieved using low-temperature heat. And, when a laser irradiating plug is used in the functional substance treatment device, a material of an alloy or a metallic compound is heated at high temperatures to be separated by gasifying, and then cooled, causing a hydrogenation or a reduction of the metal. In a case of the reduction of the metal, for example, coarse particles of a magnesium oxide and the like is charged in the pressure-resistant vessel and irradiated with the laser from the irradiation plug of the temperature control section to be heated at high temperature and gasified. And, oxygen is discharged into air and a gas of magnesium is cooled to form a metallic fine powder. And, an activation of the functional substance and a charging of the hydrogen storage container with hydrogen can be carried out. In a case of the activation, by recycling hydrogen used at the activation by restoring for reactivation, hydrogen is not wasted, and an activation (charging with hydrogen) of the hydrogen storage container to which a complex substance and the like are mounted can be carried out with low cost. As the laser source of the laser irradiating plug, a sunlight directly condensed by a lens or a reflection mirror may be used. Also, an electromagnetic wave having a necessary wavelength which is excited and amplified by using an electrical power generated by an optical transducer using a solar cell, a wind energy conversion system or a usage of a biomass fuel may be used. This achieves effective use of natural or regenerable energy.

### Embodiment 4

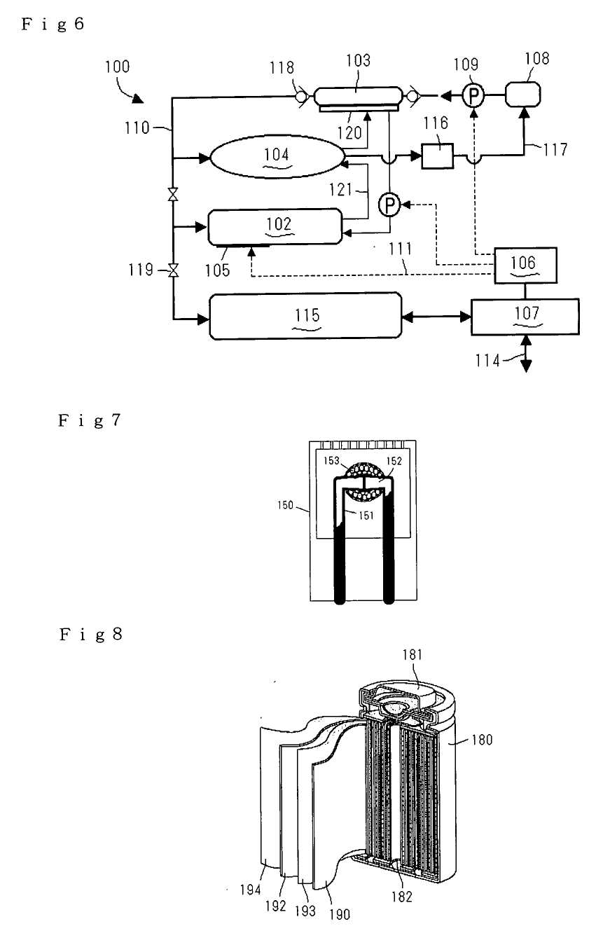

Referring to as FIG. 6, the hydrogen utilization device using a functional product is provided with a hydrogen storage container 102, a hydrogen-generating device 103, a hydrogen utilization body 104 (such as a hydrogen engine and a fuel cell), a heating device 105, an electrical control unit 106, a power distribution section 107, a water tank 108 and a pump 109, which are united. Further, a nickel-hydrogen cell 115 and the like may be provided if necessary.

On a platform of the hydrogen-generating container 103, a heating device 120 using a heating medium which receives exhaust heat from the hydrogen utilization body is placed, through the heating device 120 the heating medium is circulated by the electrically controlled pump. The hydrogen generating device 103 is filled with a functional substance in which a fine powder of Mg or magnesium hydride is made into a film with water-soluble aliphatic polyester based resin and the like and the film is made into a coarse powder. And, the hydrogen-generating device 103 formed with a hydrogen nozzle having a one-way valve 118 and a liquid nozzle at one end thereof is detachably placed on the platform. A water flows in the hydrogen-generating container 103 through the liquid nozzle from the water tank 108 and permeates through the film in a suitable amount, causing a hydrolysis of the functional substance to gasify hydrogen. Also, in a case of a metal hydride, an unstably fixed hydrogen is gasified. The generated hydrogen is supplied to the hydrogen utilization body to bond with oxygen in air to generate a water. The generated water is returned to the water tank through a separator 116 and circulates through the device. The water acts as a raw material water used for generating hydrogen by a hydrolysis of the functional product in the hydrogen-generating device. A water discharged through the hydrogen nozzle from the hydrogen-generating device 103 together with hydrogen is circulated to the water tank 108 through a bypass pipe after separating from the hydrogen gas and excessive water is discharged. In case of controlling generating of hydrogen, a quantity of water is adjusted by the pump 109 which supplies a raw water, or the generated hydrogen gas is directly supplied to the hydrogen generating device 103 through the bypass pipe and a water in the container is rapidly discharged outside to eliminate generating of hydrogen.

As the functional product mounted in the hydrogen-generating container, in which a functional substance is hydrogenised and made into a film, in addition to Mg, metals which dissociate hydrogen, their alloys and compound; alkali metal such as Li, their alloys and compounds; alkali earth metals such as Ca, their alloys and compounds; carbonaceous elements such as Si, their alloys and compounds; Al, its alloys and compounds; and other publicly known functional substance are used. And, if necessary, a small amount of acid or alkali material may be mixed with the functional substance.

The hydrogen storage container 102 has the same structure as that of the hydrogen storage and release device 6 described in Embodiment 2, and has a heating medium passage which receives exhaust heat from the hydrogen utilization body therein. Through the passage, the heating medium is circulated by the electrically controlled pump to adjust a hydrogen pressure in the device at constant. As the hydrogen storage container, a pressure-resistant container may be used.

The hydrogen utilization device in which a fuel cell is used as a hydrogen utilization body is operated in the following manner. The heating device 105 heats the hydrogen storage substance in the hydrogen storage container 102 by electric power controlled at the electrical control unit 106. [symbol] By the heating, a hydrogen gas is generated from a metal hydride contained in the hydrogen storage substance to activate the hydrogen utilization body 104. [symbol] A solution supply device 109 is operated by electric power controlled by the control unit 106 so that a liquid water in the water tank 108 is supplied to the hydrogen-generating device 103 to cause a hydrolysis and also accelerate a reaction in the hydrogen-generating container by using heat generated from the hydrogen utilization body. [symbol] The generated power is transferred to the power distribution section 107. [symbol] The heating of the heating device 105 is stopped so that the hydrogen storage substance in the hydrogen storage container 102 stores excessive hydrogen to be prepared for hydrogen release at a starting of the hydrogen utilization body and a time at which a large quantity of hydrogen is used.

A series of charging operations of a hydrogen utilization device provided with the Ni-hydrogen battery 115 will be explained. The power distribution section 107 is operated to supply power to the nickel-hydrogen battery to generate a hydrogen gas from a positive electrode and then store the hydrogen gas in a negative electrode. [symbol] Excessive generated hydrogen gas is stored in the hydrogen storage substance in the hydrogen storage container 102 to be prepared for discharging.

And, in a case of a Nickel-hydrogen battery, using the hydrogen-generating container 103 becomes it possible to generate a hydrogen gas, and then dissolve and reduce the hydrogen gas in an electrolytic solution to generate an electrical power even if a poor charge state. Besides, in a case in which the nickel hydrogen battery is used under a high consumed state, the corrugated portion of the plate of the hydrogen storage container is made of a porous material for forming a stacked product and an electrolytic solution of the battery is directly circulated through a heating medium room between the plate cassettes via a pipe. This makes it possible to supply a hydrogen ion dissolved from the hydrogen storage alloy to a positive electrode directly. So, since a time in which a hydrogen ion is returned to a molecular and then dissolved in electrolytic solution again is omitted, an operation time may be shortened.

In a case in which a hydrogen utilization body is used as a hydrogen engine of a car, the hydrogen utilization body is used in the same way as the fuel cell. And, in a case of hybrid system (using an internal-combustion engine and an electrical motor together) equipped with a hydrogen engine, the above nickel-hydrogen battery may be combined. And, a lithium based secondary battery may be combined.

### Embodiment 5

Referring to FIG. 7, a gas sensor for detecting a gas will be explained. The gas sensor uses a functional substance of a catalytic material as a gas detector 153. The gas sensor has a structure in which a fine powder of the catalytic material as the gas detector 153 is attached around a conductive junction 152 of a thermoelectric couple at which ends of two types of conductive metallic wire are joined. The gas detector is contained in a detachable container 150 to form the gas sensor.

The detachable container 150 in which the gas sensor is contained is plugged into a socket. Two types of conductor which is conducted to each metallic conductive wire of the thermoelectric couple in the socket are connected to an electrically control unit having a power source and a Thomson effect controlling device or a Seebeck effect controlling device.

As the thermoelectric couple, general used industrial thermoelectric couples in which both ends of two kinds of metallic conductive wire made from, for example, such as chromel and alumel, iron and constantan, and copper and constantan, are joined may be used without limitation. In such thermoelectric couple, the conductive metallic wires may be inserted into a metallic pipe via an insulating pipe, or, may be inserted into a tube and then magnesium oxide is filled in the tube for insulation.

The detachable container 150 is an injection-molded container made of plastic material, and has a plurality of fine pores through which gas molecule can be passed. The detachable container 150 has a gas sensor contained therein and united therewith. When heat-resistant and pressure-resistant are required, the detachable container is made of a metallic material and a portion in which the gas sensor is placed is made such that a plurality of fine pores are formed in order to pass gas molecules. And, the container is preferably made of ceramics for better function.

In the case of the gas sensor for detecting hydrogen, as the functional substance of the catalytic substance, a hydrogen storage alloy, for example, alloys of Cu, Ca, La, Mg, Ni and Ti, further LaNi based alloys and MgTi based alloys may be used. However, kinds of the catalytic substance and producing method are not limited.

A way in which a powder of a hydrogen storage alloy is made into a film may include a wet coating method and an electric discharging method such as CVD and PVD in which a metal such as Cu, Ca, La, Mg, Ni and Ti, a polymer, an oxide and a carbide is used for making into a thin film, in addition to the method in the present invention.

In such a gas sensor, by selecting a functional substance which absorbs a specific gas and using, various type of gas sensor can be provided.

Not shown in figure, in the case of an electrochemical device which uses a selected functional substance as a diffusion catalyst layer, an electrochemical device, in which a diffusion catalyst layer is formed on an outer surface of a proton conduction film (conductor) having an electrode layer formed on the both sides thereof, and a conductive joint of a thermoelectric couple and an electrochemical device are joined together or integrally inserted, and contained in a detachable container. And, the conductive metallic wires of the thermoelectric couple and the wires of the electrochemical device are connected to the electric control unit through the detachable container.

In the case of a cylindrical electrochemical device, a diffusion catalyst layer, an electrode layer and a functional membrane of a proton conduction film (conductor) are formed on an outer surface of a conductive joint of a thermoelectric couple and constructed in a unit, and contained in a detachable container. And, the conductive metallic wires of the thermoelectric couple and the wires of the electrochemical device are connected to the electric control unit through the detachable container. As materials of the diffusion catalyst layer, the electrode layer and the functional membrane of a proton conduction film (conductor), publicly known materials may be used without limitation.

In a case of a gas sensor using a surface acoustic wave (SAW) device in which an electrode and a functional membrane of a gas-reacted membrane are formed on a surface of a spherical body or an oval body, a gas reactant and a conductive joint of a thermoelectric couple are joined together or integrally inserted in a unit, and contained in a detachable container. And, the conductive metallic wires of the thermoelectric couple and the wires of the electrochemical device are connected to the electric control unit through the detachable container.

In a case of a gas sensor in which a gas reactant (an electrochemical device and a surface acoustic wave (SAW) device) is joined with a conductive joint of a thermoelectric couple, the gas reactant measures a concentration of gas and outputs the value to the control unit, and the thermoelectric couple detects a temperature by a Seebeck effect and controls an environmental temperature by a Thomson effect, causing improvement in the precision of the gas sensor. Since the gas reactant (an electrochemical device and a surface acoustic wave (SAW) device) can react with various type of gas by selecting the catalytic substance suitably, it becomes possible to downsize an integral gas sensor which detects a variety of gas at the same time.

### Embodiment 6

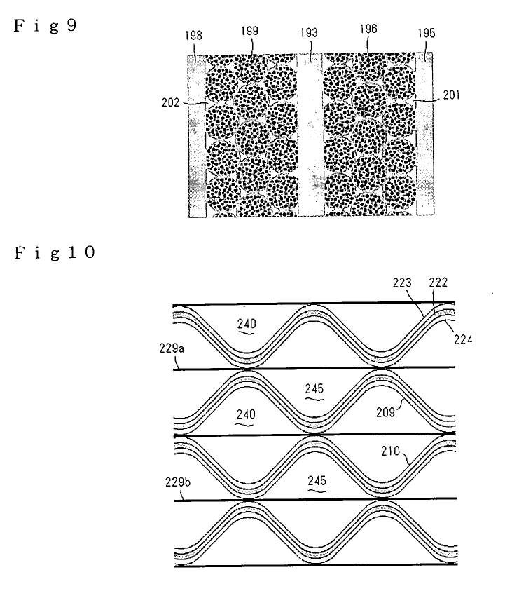

Referring to FIGS. 8 to 10, this embodiment according to the present invention will be explained. As shown in FIG. 9, an positive electrode 195 of a power generating elements on which a positive electrode active material 196 using a functional product as an active material is mounted, a separation membrane 193 and a negative electrode 198 on which a negative electrode active material 199 is mounted are joined together to unite the power generating elements.

In a case of a nickel-hydrogen battery, the power generating elements containing a positive electrode on which a nickel hydroxide is mounted as a positive electrode active substance, a separation membrane and a negative electrode on which a hydrogen storage alloy is mounted as a negative electrode active substance are joined together to be united. In a case of a lithium-metal battery, a positive electrode on which a metal oxide containing Lithium is mounted as a positive electrode active substance, a separation membrane and a negative electrode on which carbon, tin or silicon, or a compound thereof is mounted as a negative electrode active substance are joined together to be united.

In a case of a reversible fuel cell, a positive electrode in which carbon, iridium based alloy and oxide and the like is mounted to a functional substance of an oxygen pole (a positive electrode in a case of electrolysis of water), an electrolytic membrane made of a fluorocarbon polymer and the like and a hydrogen pole (a negative electrode in a case of electrolysis of water) on which platinum black and the like is mounted forms a MEA (Membrane Electrode Assembly).

In a case of a fuel cell, as a functional substance for the electrolytic membrane, a functional substance of a fine powder of metal or alloy which dissociates hydrogen, the fine powder being coated with carbide or oxide, or a carbonaceous fine powder or a fine powder of carbide or oxide, into which a proton conductive group is introduced and the like may be used, in addition to an organic polymer such as fluorocarbon polymer. As the material of the functional substance of those electrodes and electrolytic membrane (including a separation membrane), publicly known functional substances may be used.

FIG. 8 shows a cylindrical nickel-hydrogen battery or a lithium ion battery in which a positive electrode 190 and a negative electrode 192 are spirally winded with an insulation film 194 therebetween and inserted into a cylindrical case 180.

In a case of a lithium ion battery, the power generating elements consisting of the positive electrode 190 in which an active substance layer mainly consisting of LiCoO₂ is formed on a core made of aluminum, the negative electrode 192 in which an active substance layer mainly consisting of graphite is formed on a core made of copper, the separation membrane 193 separating both electrodes are spirally winded together and stored in the cylindrical case 180. And, the cylindrical case 180 is charged with an electrolyte solution in which LiPF₃ is dissolved in a mixed solvent of ethylene carbonate (EC) and dimethyl carbonate (DNC), and then sealed by a sealing body.

In a case of a nickel-hydrogen battery, a positive electrode in which a nickel hydroxide is mounted to a positive electrode active substance, a separation membrane and a negative electrode in which a fine powder of a hydrogen storage alloy is mounted to a negative electrode active substance are spirally winded together in the same manner and contained in the cylindrical case with an electrolyte solution.

The positive electrode, the separation membrane containing a solid polymer and the negative electrode, which are the power generating elements, are united and sandwiched between insulation films 194. Then, both sides of the unit are heat-pressed so that the power generating elements are packed. And then, the pack is spirally winded and inserted into a case. Such structured battery acts without leakage of the electrolyte solution and without decreasing of electric conductivity since the functional substance is pressed with a suitable force.

In which case, the electrodes are made in the following manner. The functional substance is pre-made into a fine powder having a particle diameter smaller than a fine powder in use. For example, in a case of a negative electrode of a nickel-hydrogen battery, a hydrogen storage alloy is made into a fine powder having the above particle diameter. And, in a case of a lithium-metal battery, tin or silicon is made into a fine powder having the above particle diameter. And, each of the fine powders is kneaded with a low-temperature plastic water-soluble polymer resin diluted with water to form a paste. Then, each electrode is coated with the paste, and after drying the paste by heating, a pressure bonding is carried out to form each electrode. The low-temperature plastic water-soluble polymer resin is made by preparing, for example, a polyolefin based resin, or a polyolefin based resin and a ethylene tetrafluoride based resin suitably. An emulsion type water-soluble polymer resin dispersed in water may be used. As materials of the active substances of the electrodes, the separation membrane and the electrolyte solution, publicly known materials may be used.

In a case of an electrode to which a functional substance is mounted using a low-temperature plastic water-soluble polymer resin, a hydrogen storage alloy in a case of a negative electrode of a nickel-hydrogen battery, and tin or silicon in a case of a negative electrode of a lithium-metal battery does not become into a fine powder after mounted to the electrode. In addition, the functional substance is prevented from detaching from the electrode because the plasticity of the resin responds to expanding and shrinking of the fine powder. This causes lengthening the life of the secondary battery.

### Embodiment 7

Referring to FIG. 10, a reversible fuel cell produced by stacking a MEA (Membrane Electrode Assembly) plate will be explained. Each of two plate electrodes 209 and 210 is formed with a concave plane portion and a convex plane portion. And, at a center of each of the concave plane portion and the convex plane portion, a flow hole is formed for flowing hydrogen (fuel). Each of the plates is formed with a corrugated portion over the entire surface thereof. On the corrugated portion, parallel straight grooves are formed such that the grooves on one plate are perpendicular to the grooves on the other plate when the plates are stacked. Pluralities of fine pores through which hydrogen (fuel) can be passed are formed over the entire surface of each corrugated portion. The two plates are stacked and folded at both side surfaces in the longitudinal direction to form a cassette.

The plate is made by a press molding of a metal plate when acts as an electrode also. When the plate is made of a polymer, a conductive band is formed by printing after an injection molding of the plate. And, it is preferable to keep the distance between the plates constant by placing a long board extending in the longitudinal direction of the plate between the plates. In which case, a pressure-resistance is improved when the stacked product is restricted from both sides thereof with bolts.

On the corrugated portions of the electrode 209 (a positive electrode in the case of electrolysis of water) and the electrode 210 (a positive electrode in a case of electrolysis of water), a oxygen pole diffusion layer 223, an ion-exchange membrane 222, a hydrogen pole diffusion layer 224, a hydrogen pole electrode and a conductor are formed in the order from both sides of the electrode to outside resulting in forming a MEA (Membrane Electrode Assembly) plate in which the power generating elements are combined.

A cassette composed of thus structured plate allows passing of oxygen (air) through the inside thereof. And, when the cassette is stacked, hydrogen (fuel) can be passed between the cassettes. So, since a passage of hydrogen (fuel) is separated from a passage of oxygen (air), a separator is not necessary.

And, the flow holes are formed at both ends of the plate in the longitudinal direction of the plate. In a case where the plate is used as a fuel cell in which hydrogen (fuel) does not generate CO₂ like with a pure hydrogen fuel, one flow hole may be formed on the surface of the plate. On the other hand, when a carbon hydride based reformed gas is used as a fuel, two holes are necessarily formed at both ends of the surface for passing offgas such as CO₂.

On the conductive band at both sides of the cassette, insulators 229a and 229b are placed between the cassettes in order to stack the cassettes and connect the cells serially. On both sides of the film-shaped insulator, a power collection band is formed so as to connect the electrodes serially. In the stacked product, the collection band is connected to a connection terminal of the hydrogen pole, drawn outside and then serially connected to the conductor of the plate of the oxygen pole.

In a conventional fuel cell and a water electrolytic device, two functional members (a separator and a MEA) are combined to form a stack to be functioned. However, in the present invention, a single body of a MEA (Membrane Electrode Assembly) plate is functioned as a functional member. In the functional member of a MEA (Membrane Electrode Assembly) plate according to the present invention, publicly known materials of a diffusible catalytic substance and an electrolytic membrane used in conventional membrane materials can be used as a new component. A method for forming a membrane and materials of the membrane may be not limited, and the production method may include a dipping method, a spray method, a brushing method using a material and the like. In the dipping method, in addition to a conventional dipping method in which a base substance is immersed into a slurry under air, publicly known method such as a method using a sintering if necessary may be included.

When a film shaped reversible fuel cell is formed, a plate formed with a corrugated portion having a plurality of fine pores over the entire surface thereof, or a plate formed with a MEA (Membrane Electrode Assembly) on one surface thereof is used. The plates are combined each other such that the MEA (Membrane Electrode Assembly) are faced each other. And, a periphery of the combined plates is coated with an outer coating film formed with pores over the film. On both ends of the plates, a hydrogen (fuel) nozzle is attached for passing hydrogen (fuel) through the inside of the two plates. And, both outer sides of the battery are exposed in air.

When the plate is commonly used as an electrode, the plate is formed by a press forming of a metal film. When the plate is made of a polymer, a conductive band is formed by printing and the like after the press forming of the polymer film. On the corrugated portion, each layer of the MEA (Membrane Electrode Assembly) layers and a conductive band are formed. On the plate, a conductive band (in a case of a polymer), and an oxygen (air) pole, an electrolytic membrane and a hydrogen (fuel) pole, which are layers of the MEA (Membrane Electrode Assembly), are formed in the order, and on the uppermost surface, a conductive band is formed.

By using such constructed film-shaped fuel cell, the fuel cell can be transformed into various shapes such as a plane shape, a curved shape and a winded shape corresponded to installation state. And, during operation, since the cell is constantly exposed in air, the generated water is vaporized naturally. So, a powered air blow is not necessary.

This invention is not limited to the embodiments specifically exemplified above, but is intended to cover various modifications and improvements included within the spirit and scope of the appended claims.

### INDUSTRIAL APPLICABILITY

As described above, making a functional powder into a film allows to provide high performance to a device to which the film is applied, and also to provide a weight reduction and a cost reduction of the device. In a treatment device of a functional substance, a device for reducing of a metal or for producing a fine powder of a metal hydride can be provided. And, using a magnesium hydride and the like allows a safe storage and transportation of hydrogen and generating a large amount of hydrogen. In addition, a magnesium after a hydrolysis can be secondary used in medical, industry and agricultural fields. In a society using hydrogen, the present invention brings successful results in global environment conservation.

What is claimed is:

1. A functional product, a treatment device of a functional substance, an applied device of a functional substance and a mounting method of a functional substance,
wherein said functional product uses a functional product means in which a fine functional powder of nanometer size or a fine functional powder of nanometer size packed together using a coating material is made into a solid or granular membrane;
said treatment device of a functional substance comprises:
single or plural of treatment container means which is a pressure-resistant container provided with a flange, a jacket and a temperature control section;
a hydrogen filling means having a deaerating device and a hydrogen storage and release device which are mounted on said pressure-resistance container;
a heating and cooling device having a heating device and a cooling device which are mounted on each of said pressure-resistant container and said hydrogen storage and release device; and
an electric control means for automatically controlling said treatment container, said hydrogen filling means and said heating and cooling means;
a storage device for a functional product comprises a energy conversion and storage means for sealing and storing a functional product, which has been subjected to a reduction and a hydrogenation of a functional substance using natural or regenerable energy, in a waterproof container or bag;
a molded product, a painting material, a coating material and a grouting material using said functional product comprises a catalytic means in which a material, a binder and a functional catalytic product are mixed and dispersed;
a hydrogen solvent using said functional product comprises a hydrogen solution means in which a functional product consisting of a hydrogenated functional substance is mixed with a granular, solid or viscous medicine, food or adhesive membrane material, or is filled in a container;
a hydrogen utilization device using said functional product comprises:
a hydrogen discharge means comprising a hydrogen generating container on which a functional product consisting of a functional hydrogenated substance is mounted;
a hydrogen storage and release means comprising a hydrogen storage container using a hydrogen storage substance on which a heating device is attached;
a hydrogen generating means for reacting said functional product of said hydrogen discharge means with liquid water to form a metal hydride and to generate a hydrogen gas from a hydrolysis;
a row material water supply means for supplying the hydrogen gas generated by said hydrogen generating means to a hydrogen utilization body and applying water being compounded with oxygen to said hydrogen generating means; and
an electric control means containing a detection system;
wherein these means are constructed in a unit;
a gas sensor using said functional product comprises:
a composite element means comprising a gas reactant on which a measuring junction of a thermoelectric couple and a functional product are mounted;
a detachable means for storing said composite element means in a detachable container; and
an electric control means comprising an electric control unit consisting of a power source for controlling said composite element means, a Thomson effect control system and a Seebeck effect control system and the like;
a secondary battery using said functional product comprises:
an electrode means formed by using a functional product of an active substance and a low-temperature plastic coating material; and
an unifying means bonding power generating elements comprising a negative electrode, a positive electrode and a separation membrane of said electrode means and covering the elements with an insulation membrane;
a fuel cell or reversible fuel cell in which said functional product is used in a MEA (Membrane Electrode Assembly) plate comprises:
a MEA (Membrane Electrode Assembly) plate means in which a MEA (Membrane Electrode Assembly) is formed on one side of a plate formed with a corrugated portion;
a stacking means stacking a single body of said MEA (Membrane Electrode Assembly) plate, a MEA (Membrane Electrode Assembly) cassette in which two of said MEA (Membrane Electrode Assembly) plates are stacked, or the MEA (Membrane Electrode assembly) cassettes; and
a sealing means covering said single body of MEA (Membrane Electrode Assembly) plate or said MEA (Membrane Electrode Assembly) cassette with a coating material, or, bonding the periphery of said stacked MEA (Membrane Electrode Assembly) cassettes, sealing and separating an inside of a positive electrode or a negative electrode and providing nozzles for a fluid of two passages.

2. The functional product according to claim 1 comprising one or more kinds of materials following (1) to (9):
(1) Halogen elements or their compounds;
(2) Oxygen family elements, or their alloys or compounds;
(3) Nitrogen family elements, or their alloys or compounds;
(4) Carbon family elements, or their alloys or compounds;
(5) Alkali metal elements, or their alloys or compounds;
(6) Alkali earth elements, or their alloys or compounds;
(7) Zinc, cadmium and mercury, or their alloys or compounds;
(8) Boron family elements, or their alloys or compounds; and
(9) The forth, fifth, sixth and seventh periodic group transition elements, or their alloys or compounds.

3. The functional product according to claim 1 or 2,
wherein said functional product is produced in a way that an original functional substance is made into a fine powder having a necessary particle diameter of 3 μm or less to within 1 nm and treated by any of the following manner (1) to (3), and the treated fine powder is further treated through a coating process wherein the powder is mixed with a coating material and a solvent to form a paste, and then the paste is solidified, or the solidified paste is ground into a coarse powder;
(1) A functional substance is charged into a container with an inert gas and the like and then subjected to a mechanical grinding treatment or to a laser irradiation in which the functional substance is heated at high temperatures to be gasified and then cooled to form a fine powder;
(2) A functional substance is charged into a pressure-resistant container with hydrogen to cause a hydrogenation reaction which brings self heating resulting in forming a fine powder containing a crystal of metallic hydride; and
(3) A carbonaceous material and an alkali metal material are placed with a distance therebetween in a vacuum vessel and the vessel is sealed, each of the temperatures of the carbonaceous material and the alkali metal material is individually controlled to cause a gas phase reaction to form a fine powder in which metal atoms of the alkali metal are inserted between planer molecular layers of the carbonaceous material.

4. The functional product according to any one of claims 1 to 3 used in any one of the following purpose (1) to (7):
(1) A catalyst, a molded product, a coating material and a grouting material and the like;
(2) Solving hydrogen in liquid, mixing said product into a medicine and a food, a container and the like;
(3) Storage of energy, to store in a waterproof container or bag and the like;
(4) Generating hydrogen accompanied with a hydrolysis, in which said product is cooperated with a hydrogen utilization body and used in a container of a circulation passage of a raw liquid water and the like;
(5) Detecting gas, a detector and the like;
(6) Purifying or storage (absorb and storage) of a specific substance, a heat pump or pressurizing hydrogen, each of which is used in an apparatus and the like; and
(7) A fuel cell, a water electrolytic equipment or a secondary cell, a membrane of MEA (Membrane Electrode Assembly), power generating elements such as an electrode and the like.

5. The treatment device of a functional product according to any one of claims 1 to 4,
wherein said temperature control section of said treatment container means is provided with a heating wire, an electrothermal plug or a laser irradiating plug.

6. The treatment device of a functional product according to any one of claims 1 to 5,
wherein said laser irradiating plug uses a condensed sunlight or an excited electromagnetic wave amplified by power conversed from natural or regenerable energy as a laser source.

7. The treatment device of a functional product according to any one of claims 1 to 6,
wherein a metal, alloy or metal compound is put in said pressure-resistant container of said treatment container means,
hydrogen or inert gas is charged into said pressure-resistant container,
a laser irradiates the compound to heat them at high temperature and to gasify the compound, and then
the gas is cooled to cause a hydrogenation of metal or a reduction of metal.

8. The hydrogen storage and release device according to claim 1, produced by the following steps:
forming a hydrogen hole at a planner portion of a metal plate having a corrugated portion,
sandwiching a board material between two of said metal plates and then brazing to form a plate cassette,
mounting and adhering a functional product on the grooves of the corrugated portion of both sides of said plate cassette,
stacking said plate cassettes and then welding the peripheral bonded portion of the stacked cassettes to form a stacked product having a sealed hydrogen room, and
mounting a heating medium nozzle at both sides of said stacked product and a hydrogen nozzle to the hydrogen hole on the upper side of said stacked product.

9. The hydrogen storage and release device according to claim 1 or 8 being used in any one of the following purpose (1) to (4) regardless of size:
(1) Storage of gas, in which the device is used for storing (absorbing) and transferring;
(2) Purifying gas, in which the device is used for obtaining a high-purity gas from a mixture gas or a low-purity gas;
(3) Heat pump, in which the device is used for collecting heat of hydrogenation or endothermal heat from a hydrogen discharge reaction; and
(4) Pressuring hydrogen, in which the device is used for a reduction and an activation of a substance, and for pressurizing hydrogen.

10. The hydrogen solvent according to any one of claims 1 to 4,
wherein a hydrogen solving means comprises;
a mixture in which a powder of an objective product such as food, nutriment and medicine is mixed with a functional product of a metal hydride,
said mixture is kneaded with a solid formulation and then molded using a die,
said mixture and a powder of dry organic polymer are mixed, kneaded, pressed using a die and then heated, or
said mixture is pressed using a die, coated with a liquid organic polymer and then dried by heating.

11. The hydrogen solvent according to any one of claims 1, 2, 3, 4 and 10,
wherein said hydrogen solving means is such that a container formed with a plurality of fine pores through which a liquid can be passed is filled with a functional product of a metal or a metal hydride.

12. The hydrogen utilization device according to any one of claims 1 to 4,
wherein said hydrogen discharge means is a container in which a hydrogen generating container is covered with a functional product of a metal or a metal hydride on its inner surface and provided with a hydrogen nozzle and a liquid nozzle each having a one way valve detachably mounted thereon.

13. The hydrogen utilization device according to any one of claims 1, 2, 3, 4 and 12,
wherein the hydrogen generating means and the hydrogen storage and release means have a heat source using a heat generated from a hydrogen utilization body.

14. The gas sensor according to any one of claims 1 to 4,
wherein the gas reactant of the composite element means has the following structure (1) to (4) for detecting gas:
(1) A functional product is mounted around a conductive junction of a thermoelectric couple;
(2) An electrochemical device in which a proton conductive membrane (a proton conductor) having an electrode layer on both sides thereon is formed with a diffusion catalyst layer comprising a functional product at outer surface thereof, to which a conductive junction of a thermoelectric couple is bonded or inserted;
(3) A cylindrical electrochemical device in which a diffusion catalytic layer, an electrode layer and a proton conductive membrane (a proton conductor) are formed around a conductive junction of a thermoelectric couple; and
(4) A spherical or oval surface acoustic wave (SAW) device to which a conductive junction of a thermoelectric couple is bonded or inserted.

15. The fuel cell or reversible fuel cell according to any one of claims 1 to 4,
wherein the electrolytic membrane of the MEA (Membrane Electrode Assembly) plate has the following functional product (1) to (4) to which a proton conductive group is introduced;
(1) An organic polymer,
(2) A functional product of a metal or alloy which dissociates hydrogen, the functional product being coated with a carbide or oxide film;
(3) A carbonaceous fine powder; and
(4) A fine powder of a carbide or oxide.

16. The reproduction method of a functional substance to be hydrogenated according to any one of claims 1 to 15,
wherein a metal oxide is put in a pressure-resistant container and an inert gas is introduced to the container,
the metal oxide is irradiated with a laser to separate the metal oxide into an oxygen gas and a metal,
the oxygen gas is discharged in air and the metal gas is cooled in the inside of the container to be reduced,
the pressure-resistant container is charged with high-pressure hydrogen so that one end part of the reduced metal is fired by a laser irradiation, and
the reaction is accelerated using self-heating of a hydrogenation reaction to obtain a fine powder of a metal hydride.

17. The coating method of a functional substance according to any one of claims 1 to 16,
wherein one or more kinds of a water-soluble organic polymer resin containing a water-soluble organic polymer resin containing in which aliphatic polyester, polyolefin or ethylene tetrafluoride is dispersed in water, or an organic solvent-soluble polymer resin or several kinds thereof is diluted with a solvent and then kneaded with a functional product of a fine powder,
the kneaded product is heated to cause a glass transition and to be solidified for forming a membrane, or
a dry fine powder of a water-soluble polymer resin or an organic solvent-soluble polymer resin is mixed with a functional substance of a fine powder and heated to cause a glass transition to be solidified for forming a membrane, or,
the solidified membrane is ground into a coarse powder.

18. The mounting method of a functional product according to any one of claims 1 to 17 comprising one of the following three ways:
the first way in which a functional substance of a coarse powder made into a membrane and a binder diluted with a solvent are kneaded to form a paste, the paste is dried by heating to be solidified into a desired shape, and then the solidified paste is filled and installed in an objective apparatus or the inside and outside of the pipes of the apparatus, or
the grooves of the corrugated plate or the electrode is coated with the paste and then dried by heating so that the paste is solidified and adhered thereto;
the second way in which a functional product of a fine powder of nanometer size is kneaded with a binder diluted with a solvent to form a paste, an objective apparatus or the inside and outside of the pipes of the apparatus is coated with the paste, or the grooves of the corrugated plate or the electrode is coated with the paste, and then the paste is dried by heating to be solidified and adhered, and then the solidified paste is coated with a coating material diluted with a solvent to be made into a membrane; and
the third way in which a functional product of a fine powder of nanometer size and a coating material diluted with a solvent is kneaded to form a paste, an objective apparatus or electrode is coated with the paste and the paste is dried by heating and solidified, and the pressed thereto if necessary.
